(19) United States
(12) Patent Application Publication
(10) Pub. No.: US 2020/0057509 A1
(43) Pub. Date: Feb. 20, 2020

(54) USER-INPUT DEVICES

(71) Applicant: HEWLETT-PACKARD DEVELOPMENT COMPANY, L.P., Spring, TX (US)

(72) Inventors: Matthew FLACH, Fort Collins, CO (US); Amol Subhash PANDIT, Fort Collins, CO (US); Peter Andrew SEILER, Fort Collins, CO (US)

(73) Assignee: Hewlett-Packard Development Company, L.P., Spring, TX (US)

(21) Appl. No.: 16/340,060

(22) PCT Filed: Oct. 7, 2016
(86) PCT No.: PCT/US2016/055899

§ 371 Date: Apr. 5, 2019

(51) Int. Cl. G06F 3/02; G06F 3/01; G06F 3/041; G06F 3/0488; G06F 3/0482

(52) U.S. Cl. CPC G06F 3/0219; G06F 3/017; G06F 3/0482; G06F 3/04883; G06F 3/041

(57) ABSTRACT

In an example, a user-input device includes a first keyboard having a plurality of movable pushbuttons on a first side and a display input device on a second side. The example user-input device also includes an orientation sensor and an orientation analyzer to determine an orientation of the user-input device. The user-input device includes a communication node to communicate a determined orientation of the user-input device to an external system.

### BACKGROUND

User-input devices, such as keyboards and similar peripheral devices, include predetermined arrangement of pushbuttons or keys, each key to actuate a switch that is distinguished from switches associated with other keys by controlling software, firmware and/or hardware.

### BRIEF DESCRIPTION OF THE DRAWINGS

FIG. 1 depicts an example user-input device connected to an example external system in accordance with an example of teachings of this disclosure.

FIG. 2A is an example first side of an example user-input device in accordance with teachings of this disclosure.

FIG. 2B is an example second side of an example user-input device in accordance with teachings of this disclosure.

FIG. 3 is a flowchart in accordance with teachings of this disclosure.

FIG. 4 is a block diagram of an example processor platform which may execute the example instructions, such as instructions implementing the flowchart in FIG. 3, to implement concepts disclosed herein.

While the present disclosure is susceptible to various modifications and alternative forms, specific examples are shown and described herein. It should be understood, that the present disclosure is not limited to the particular forms and examples disclosed and instead covers all modifications, equivalents, embodiments, and alternatives falling within the spirit and scope of the present disclosure.

### DETAILED DESCRIPTION

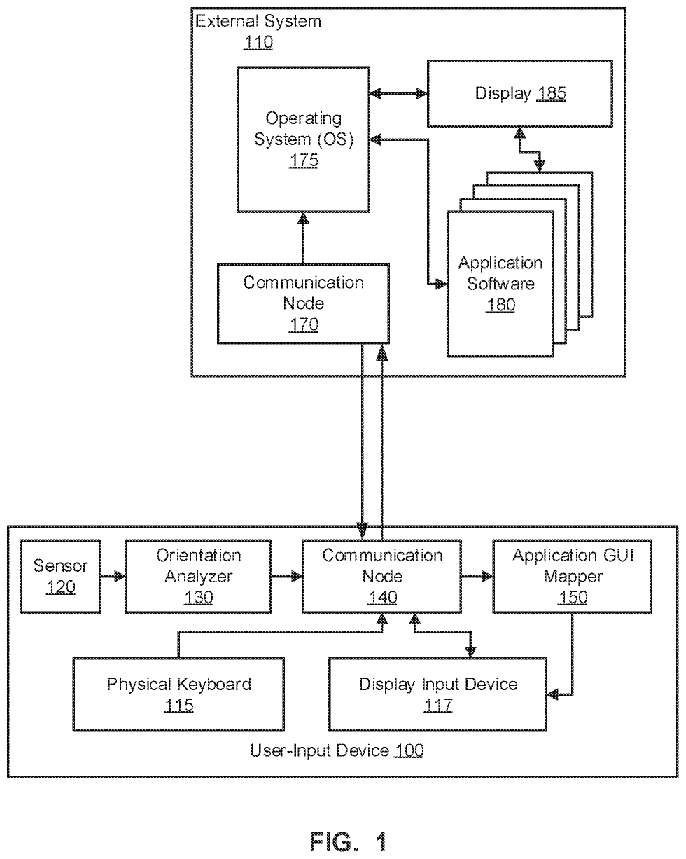

FIG. 1 depicts an example user-input device 100 connected to an example external system 110 in accordance with an example of teachings of this disclosure. FIG. 1 particularly represents an operational state of the example user-input device 100, where the example user-input device 100 is communicatively connected, via a wireless/hardwired local or remote connection, to an example external system 110, which may include a local computer (e.g., personal computer, etc.), local network, remote computer, and/or remote network. In this way, a user interacts with the example user-input device 100 to provide information to the example external system 110. Also, the example external system 110 may, upon receipt of information from example user-input device 100, change attributes of the example user-input device 100.

To support world-wide languages, keyboards are printed with permanent markings on each key such that each key is denoted with written symbols, such as a letter and/or character, which makes the keyboards language specific to one or two languages. Multifunctional keyboards provide additional functions beyond the standard keyboard, such as through additional key functions, and provide a degree of programmability or configurability to facilitate use in complex work environments

For example, an example user-input device includes a first side having an example standard, physical keyboard 115 (e.g., a QWERTY keyboard having pushbuttons, etc.) and a second side, opposite the first side, having an example configurable touch-screen display 117 adaptable to display an example keyboard corresponding to an application running in the foreground of a connected system. An example sensor detects an orientation of the example user-input device to permit determination as to which of the first and second side is an “active” side. In use, if the example touch-screen display is oriented in a “face up” or active position, the example user-input device communicates this orientation to a connected example external system and the connected external system causes the example touch-screen display to display an example keyboard corresponding to an example application running in the foreground of the example external system's operating system. In this example, the user-input device is enabled to switch layouts, based on the application used, to dynamically provide the most appropriate input layout for the active workflow. In another example, the orientation sensor may determine that the user-input device is oriented with the touch-screen display in a portrait position or a landscape position, relative to the ground, and cause a layout of the touch-screen display to adjust correspondingly.

The example user-input device 100 of FIG. 1 includes an example physical keyboard 115, an example sensor 120, an example orientation analyzer 130, an example communication node 140, an example application graphical user interface (GUI) mapper 150 and an example display input device 117. The example external system 110 includes an example communication node 170, an example operating system 175, example application software 180 and an example display 185.

The example physical keyboard 115 includes a plurality of movable keys and may include a standard alphanumeric keyboard, such as a “QWERTY” keyboard or other computer keyboard with keys 210 for alphabetic characters, punctuation symbols, numbers and various functions. The example display input device 117 is a touch-screen display, such as a multipoint or multi-touch touch-screen display enabling recognition of the presence of a plurality (e.g., two, three, four, five, ten, etc.) of contacts with the touch-screen surface. In another example, the example display input device 117 is a haptic touch-screen display. In one example, the haptic feedback occurs only in the areas of keys 210, with areas between the keys comprising a “white space” in which no haptic feedback is provided to a user. In another example, haptic feedback is user-selectable. Thus, the example physical keyboard 115 provides a tactile, familiar input to users that is conducive to faster typing speeds than may be achieved on a touch-screen keyboard, while the example display input device 117 provides an adaptable user input, that may be a user-configurable touch-screen display, enabling display of an example keyboard corresponding to an application running in the foreground of a connected external system 110 to complement the users active workflow.

An example display input device 117 has a width of between about 14″-18″ and a depth between about 4.5″-8,″ corresponding generally to a profile of a computer keyboard. In another example, the example display input device 117 includes a plurality (e.g., two, three, four, five, etc.) of adjacent touch-screen displays. These example adjacent touch-screen displays 117 have, in one example, a combined width of between about 14″-18″ and a depth between about 4.5″-8,″ again corresponding generally to a profile of a computer keyboard. To illustrate, six 2.7″×4.8″ displays are disposed adjacent one another in an abutting relationship to provide, as a whole, a display having a width of 16.2″ and a depth of 4.8.″ As another illustrative example, two 5.5″×8″ displays are disposed adjacent one another in an abutting relationship to provide, as a whole, a display having a width of 16″ and a depth of 5.5.″ While some example dimensions are denoted above for an example user-input device 100 and an example display input device 117, the present concepts include user-input devices and display input devices having other dimensions smaller than, or larger than, those provided above by way of example. By way of example, the example user-input device 100 could be a super mini keyboard having a width of 10″ and a depth of 7,″ with an example display input device 117 having dimensions less than about 10″×7.″

The example sensor 120, in one example, includes an orientation sensor to sense an orientation of the user-input device 100 and/or to sense a movement of the user-input device 100 from which an orientation can be determined. The example sensor 120 may include an accelerometer to measure proper acceleration along various axes, such as static acceleration such as gravity and/or dynamic forces of acceleration such as movement. The example sensor 120 may include a gyroscope to measure orientation via changes in angular momentum, such as changes in orientation and changes in rotational velocity or rotation rate. The example sensor 120 may include a switch that changes state responsive to orientation changes of the user-input device 100, such as a ball switch or a mercury switch. The example sensor 120 may include a combination of any of an accelerometer, a gyroscope and/or a switch and may include, for example, an Inertial Measurement Unit (IMU).

In one example, the example sensor 120 includes a STMicroelectronics LIS3DE or a STMicroelectronics LIS331DLH ultra-low-power 3-axis digital accelerometer, which measure acceleration along three orthogonal axes, permitting orientation and movement in a three-dimensional coordinate system to be determined. An example sensor 120 including an accelerometer registers, at rest, an acceleration vector due to Earth's gravity, providing an indication of an “upward” direction and a “downward” direction and provides, upon initialization of the example user-input device 100 with an example external system 110, orientation information indicating a default or initial orientation of the user-input device 100.

In another example, the example sensor 120 includes a gyroscope (e.g., a micro-electro-mechanical systems (MEMS) gyroscope, etc.) to measure orientation via changes in angular momentum, such as a STMicroelectronics L3GD20H, a low-power, three-axis angular rate sensor, which includes a sensing element and an integrated circuit (IC) interface to output the measured angular rate via a digital interface (Inter Integrated Circuit Communications (I²C)/Serial-Peripheral interface (SPI)). Gyroscopes may provide an indication of changes to an orientation, as opposed to an absolute value for orientation. Thus, an initial position may be known or otherwise set to determine the changes to the orientation. By way of example, an example user-input device 100, such as a keyboard having actuatable keys, would be initially positioned in a default position, such as with, for example, keys facing “upwardly” on a horizontal surface to present the keys to a field of view of a user, for the system to determine an initial orientation. As another example, an example accelerometer is used to provide an indication of direction, such as by using a single axis accelerometer used to denote a direction of the Earth's acceleration and, correspondingly “up” and “down”.

In still another example, the example sensor 120 includes switches that respond to changes in orientation. In one example, the example sensor 120 includes a switch object, such as a mass of mercury or a conductive or a non-conductive ball, moveable under the influence of gravity and functions to activate and/or deactivate a contact responsive to predetermined changes in orientation. For example, an example orientation switch for the example sensor 120 may maintain an open contact in one orientation, such as an “upward” orientation, and may close the contact in another orientation, such as a “downward” orientation, by virtue of the movement of a switch object completing a circuit or, alternatively, breaking a circuit. Any manner of orientation switch may be used, singly or in combination. For example, a plurality of orientation switches could be provided to represent different angular states of the user-input device 100 and/or the same angular states to provide redundant and robust (e.g., failure tolerant) sensing capabilities. In another example, contact switches or pressure switches are provided on the first side of the example user-input device 100 and/or the second side of the example user-input device 100. In such example, contact switches or pressure switches are integrated into a body of the example user-input device 100, such as in a casing of the example user-input device 100 or extensions thereof (e.g., feet of the keyboard, etc.) to register contact of a particular side of the example user-input device 100 with an underlying surface and/or a lack of contact of a particular side of the example user-input device 100 with an underlying surface.

The example orientation analyzer 130 receives the information output by the example sensor 120 and analyzes the information to determine an orientation of the user-input device 100. While represented as a component of example user-input device 100, the orientation analyzer 130 may be integrated with the sensor 120 or may be provided externally to the example user-input device 100, such as being a constituent part of external system 110. In the latter example, the information output by the example sensor 120 is provided to the communication node 140, where it may then be in turn output externally to the orientation analyzer 130, wherever resident. To illustrate, the example orientation analyzer 130 receives acceleration information output by an example accelerometer sensor 120, such acceleration information including environmental vibrations arising from keying or incidental translation of the user-input device during use as well as a gravity vector, and converts the acceleration information into a determination as to an orientation of the example user-input device 100. In an example, the example orientation analyzer 130 institutes a call to the example sensor 120 to determine the device orientation and the example sensor 120 returns to the example orientation analyzer 130 the example user-input device 100 orientation.

The example communication node 140 of the example user-input device 100 and/or the example communication node 170 of the example external system 110 includes a wireless and/or a hardwired communication pathway to enable wireless communication and/or hardwired communication between the example user-input device 100 and the external system 110, which may include, for example, a local computer, a remote computer, a local network, and/or a remote network. The communication nodes 140, 170 include, by way of example and not limitation, a USB port, a USB Type-C port, a USB 3.0 port, a USB 3.1 port, a wireless communication device, a Bluetooth device, a frequency hopping spread spectrum communication device, an adaptive frequency-hopping spread spectrum communication device, a radio frequency communication device, a 2.4 GHz wireless communication device, a Mini DisplayPort, a DisplayPort, a digital visual interface (DVI) port, an High-Definition Multimedia Interface (HDMI) port, a Wireless Display feature (WiDi) port, and/or an Institute of Electrical and Electronics Engineers (IEEE) 1394 “FireWire” port.

The example external system 110 operating system 175, upon receipt of the orientation information from the orientation analyzer 130, applies a driver corresponding to the selected one of the example keyboard 115 or the example display input device 117 to selectively enable an appropriate one of the example keyboard 115 or the example display input device 117 and to disable the other of the example keyboard 115 and the example display input device 117.

The example application graphical user interface (GUI) mapper 150 maps to the example display input device 117 of the user-input device 100 application functions from example application software 180 displayed on the example external system display 185, each of the application functions being represented by a user-selectable object, such as an icon or a soft key. In one example, this mapping is performed for an application 180 residing in a foreground or “top window” of the example operating system 175 or, stated differently, an application 180 that the user of the external system 110 is currently utilizing.

The mapping of the user-selectable objects to the example display input device 117 of the user-input device 100 is may be performed when the example orientation analyzer 130 determines that the example user-input device 100 is oriented to position the example display input device 117 of the example user-input device 100 in an “upward” orientation so as to be within the user's field of view. Alternatively, the example application GUI mapper 150 maps the user-selectable objects of an application 180 residing in a foreground of the example operating system 175 to the example display input device 117 regardless of an orientation of the example user-input device 100 and the example display input device 117. In such example, the example display input device 117 may be powered-down, such as via an app to modify a power options configuration such as a SendMessage Visual Basic command to a window procedure for a power options window of the example operating system 175, to turn off the display and/or to turn off a touch-screen layer in the event the example display input device 117 is in a “downward” orientation.

Mapping of application 180 functions by the application GUI mapper 150, wherever resident, occurs responsive to receipt by the application GUI mapper 150 of application 180 information defining the application functions to be represented as user-selectable objects on the example display input device 117. In an example, the application information is an identifier providing an identity of the foreground application to the application GUI mapper 150, whereupon the application GUI mapper 150 retrieves from a memory a stored (e.g., user-defined, etc.) mapping of user-selectable objects corresponding to the identified foreground application for display on the example display input device 117.

While represented as a component of example user-input device 100 in the example of FIG. 1, the example application graphical user interface (GUI) mapper 150 may be integrated with the example external system 110, such as in the system software, such as operating system 175, or in the application software 180.

The example operating system (OS) 175 includes any system software that manages computer hardware and software resources and provides common services for computer programs and may include, for example, Unix and Unix-type operating systems, Microsoft Windows, macOS, etc.

The application software 180 includes any application software designed to perform a group of coordinated functions, tasks, or activities and includes, but is not limited to, a word processing program, a spreadsheet program, an accounting application, a web browser, a media player, and/or a computer-aided design application. The example user-input device 100 display input device 117 is configurable to support user preferences (e.g., language, Hotkeys, special characters, DVORAK keyboard layout, etc.) as they relate to any application software 180 (e.g., CAD, games, Microsoft applications, web browsers, etc.).

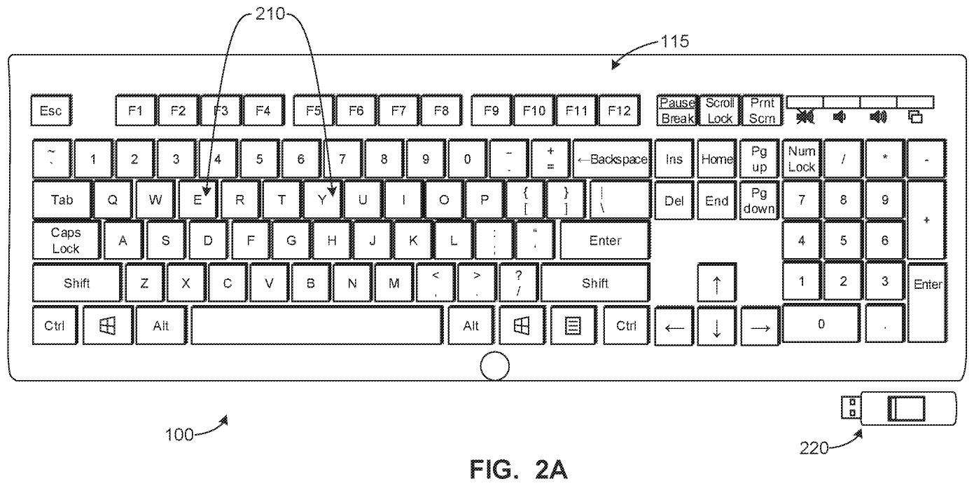

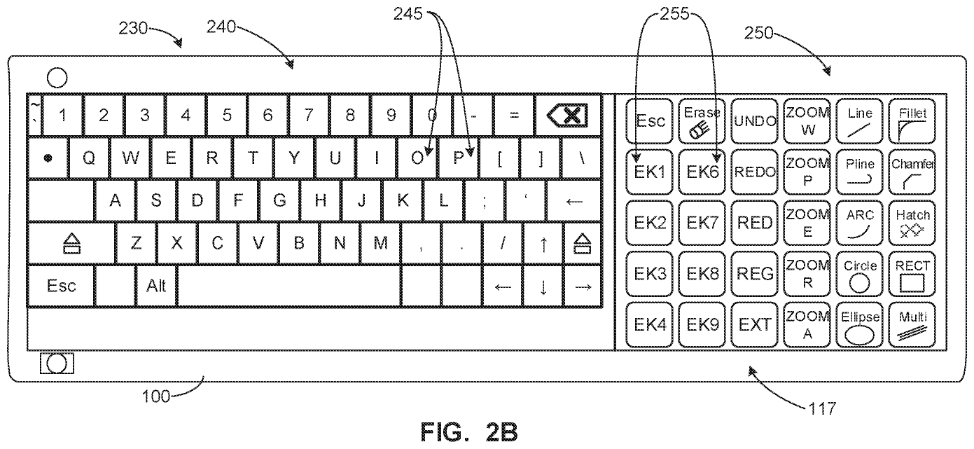

FIG. 2A is a view of a first side of an example user-input device 100, showing an example first keyboard 115 having a plurality of movable keys 210. The example first keyboard 115, as shown in FIG. 2A, is a standard alphanumeric keyboard, such as an HP TouchSmart IQ500 and IQ800 Series keyboard, with keys 210 for alphabetic characters, punctuation symbols, numbers and various functions. Adjacent the example user-input device 100 is shown an example 2.4 GHz wireless transceiver 220 enabling wireless communication between the example first keyboard 115 and the example user-input device 100 and the example external system 110. In one example, the example user-input device 100 includes a USB port into which a wireless device, such as the 2.4 GHz wireless transceiver 220, is inserted to facilitate communication between the example user-input device 100 and the example external system 110.

FIG. 2B is a view of a second side of an example user-input device 100, showing an example second keyboard 230 displayed on display input device 117, such as a touch-screen or a multi-touch touch-screen. In the example of FIG. 2B, the display input device 117 displaying the second keyboard 230 is disposed on a second side of the user-input device 100 opposite to the first side bearing the first keyboard 115 of FIG. 2A. The example second keyboard 230 has an example first section 240, including a plurality of soft keys 245 (e.g., a “QWERTY” keyboard, a “DVORAK” keyboard, etc.) for alphabetic characters, punctuation symbols, numbers and various functions. In the example first section 240 of FIG. 2B, the QWERTY keyboard is shown to be smaller than the physical QWERTY keyboard of the example first keyboard. In one example, a ratio of sizes as between the first section 240 and a second section 250 of the second keyboard 230 is variable and the size of the first section 240 and the second section 250 may be varied. For example, if a user requires a lesser number of, or smaller size of, user-selectable objects 255, the size of the second section may be decreased and the size of the first section correspondingly increased. In one example, a size of individual user-selectable objects 255, or sets of user-selectable objects 255, may be increased or decreased to support a user's needs and preferences.

In another example, a configuration of the example display input device 117 second keyboard 230 is independent of the application software.

The example second section 250 displays a plurality of example user-selectable objects 255, each of the example user-selectable objects 255 representing a different application function. In the example shown in FIG. 2B, the example user-selectable objects 255 correspond to computer-aided design (CAD) application software 180 in a foreground of the operating system 175, the example user-selectable objects 255 representing CAD functions of, for example, “circle,” “ellipse,” “polygon,” “palate,” “scale,” “offset,” “copy,” “redo,” and the like.

The example user-selectable objects 255 representing application functions, such as those representing drawing or graphic design application functions in the example of FIG. 2B, are mapped to specific locations on the display input device 117 by the application GUI mapper 150, which retrieves from a memory a stored mapping (e.g., user-defined locations, default positions, etc.) of user-selectable objects corresponding to the identified foreground application. The application GUI mapper 150 further enables the user to move, add, remove, or alter any of the user-selectable objects 255 to suit the user's preferences.

While an example manner of implementing the teachings herein, as set forth by way of example in FIGS. 2A-4 is illustrated in FIG. 1, the elements, processes and/or devices illustrated in FIG. 1 may be combined, divided, re-arranged, omitted, eliminated and/or implemented in any other way. Further, the example user-input device 100, example external system 110, example physical keyboard 115, example sensor 120, example orientation analyzer 130, example communication node 140, example application graphical user interface (GUI) mapper 150, example display input device 117, example communication node 170, example operating system 175, example application software 180 and example display 185 of FIG. 1 may be implemented by hardware, software, firmware and/or any combination of hardware, software and/or firmware. Thus, for example, the example user-input device 100, example external system 110, example physical keyboard 115, example sensor 120, example orientation analyzer 130, example communication node 140, example application graphical user interface (GUI) mapper 150, example display input device 117, example communication node 170, example operating system 175, example application software 180 and example display 185 of FIG. 1, or other examples expressly or implicitly disclosed herein could be implemented by analog or digital circuit(s), logic circuits, programmable processor(s), application specific integrated circuit(s) (ASIC(s)), programmable logic device(s) (PLD(s)) and/or field programmable logic device(s) (FPLD(s)).

When reading any of the apparatus or system claims of this patent to cover a purely software and/or firmware implementation, at least one of the example user-input device 100, example external system 110, example physical keyboard 115, example sensor 120, example orientation analyzer 130, example communication node 140, example application graphical user interface (GUI) mapper 150, example display input device 117, example communication node 170, example operating system 175, example application software 180 and example display 185 illustrated herein are hereby expressly defined to include a tangible computer readable storage device or storage disk such as a solid state memory device, a CD-ROM, a digital versatile disk (DVD), a compact disk (CD), a Blu-ray disk, etc. storing the software and/or firmware. Further still, the example user-input device 100, example external system 110, example physical keyboard 115, example sensor 120, example orientation analyzer 130, example communication node 140, example application graphical user interface (GUI) mapper 150, example display input device 117, example communication node 170, example operating system 175, example application software 180 and example display 185 of FIG. 1 may include elements, processes and/or devices in addition to, or instead of, those illustrated in FIG. 1, and/or may include more than one of any or all of the illustrated elements, processes and devices.

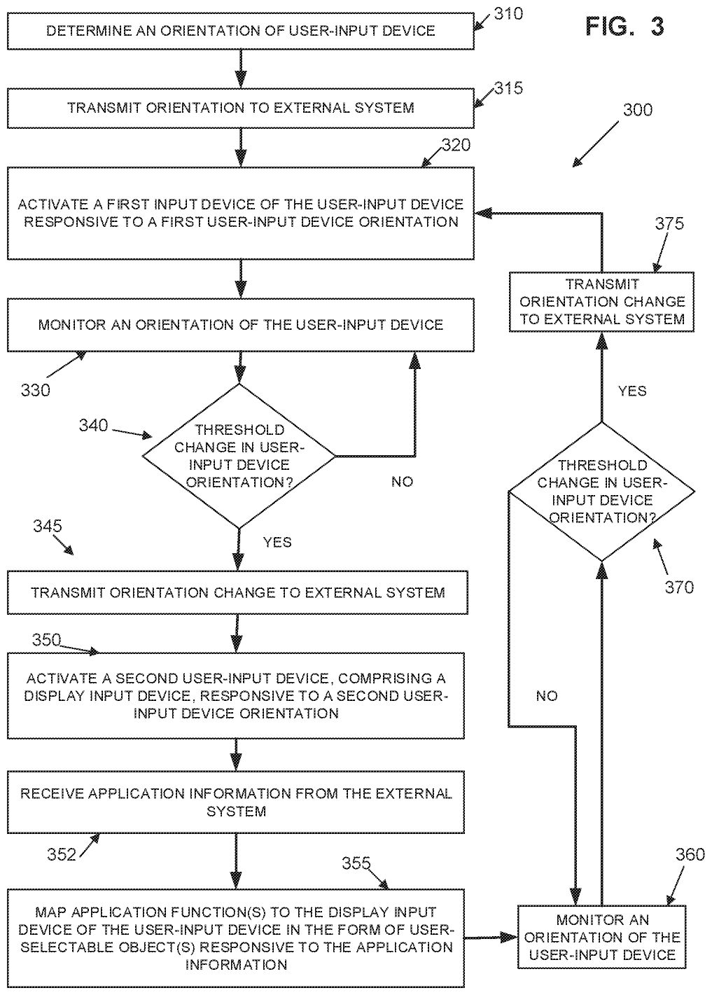

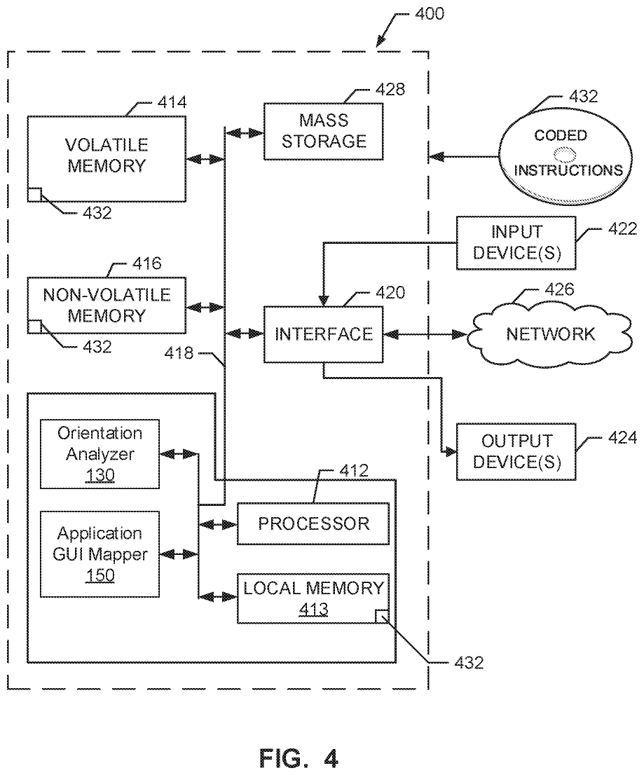

In example machine readable instructions implementing the apparatus 100 of FIG. 1, such as is shown in FIG. 3 by way of example, the machine readable instructions comprise a program for execution by a processor such as the processor 412 shown in the example processor platform 400 discussed below in connection with FIG. 4. The program may be embodied in software stored on a tangible computer readable storage medium such as a CD-ROM, a floppy disk, a hard drive, DVD, a Blu-ray disk, or a memory associated with the processor 412, but the entire program and/or parts thereof could alternatively be executed by a device other than the processor 412 and/or embodied in firmware or dedicated hardware. Further, although the example program is described with reference to the example flowcharts illustrated in FIG. 3, many other methods of implementing the example orientation analyzer 130 and example application graphical user interface mapper 150 may alternatively be used. For example, the order of execution of the blocks may be changed, and/or some of the blocks described may be changed, eliminated, or combined.

As mentioned above, the example processes of FIG. 3, or other processes disclosed herein, may be implemented using coded instructions (e.g., computer and/or machine readable instructions) stored on a tangible computer readable storage medium such as a hard disk drive, a flash memory, a read-only memory (ROM), CD, DVD, a cache, a random-access memory (RAM) and/or any other storage device or storage disk in which information is stored for any duration (e.g., for extended time periods, permanently, for brief instances, for temporarily buffering, and/or for caching of the information). As used herein, the term tangible computer readable storage medium is expressly defined to include any type of computer readable storage device and/or storage disk and to exclude propagating signals and to exclude transmission media. As used herein, “tangible computer readable storage medium” and “tangible machine readable storage medium” are used interchangeably. Additionally or alternatively, the example processes of FIG. 3, or other processes disclosed herein, may be implemented using coded instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media. As used herein, when the phrase “at least” is used as the transition term in a preamble of a claim, it is open-ended in the same manner as the term “comprising” is open ended.

FIG. 3 shows a flowchart of an example method 300 performed in accordance with teachings herein.

In block 310, an orientation of the example user-input device 100 is determined. By way of example, and with reference to FIG. 1 and FIGS. 2A-2B, the example orientation analyzer 130 interprets signals from the example sensor 120 to determine whether the orientation of the example user-input device 100 places the example first keyboard 115 (FIG. 2A) or the example display input device 117, on which the second keyboard 230 (FIG. 2B) is displayed, in an “upward” position (e.g., in a field of view of a user). In one example, this orientation determination is performed contemporaneously with a start-up sequence or an initialization of the example user-input device 100 by the operating system 175 of the example external system 110, via the communication nodes 140, 170.

Responsive to this orientation determination from block 310, the example orientation analyzer 130, in block 315, outputs orientation information relating to the example user-input device 100 to the example external system 110, via the communication node 140. In block 320, responsive to the received orientation information, the example operating system 175 of the example external system 110 activates a “first” input device of the example user-input device 100 via hardware, firmware and/or software (e.g., software stack, plug-and-play (PnP) software and drivers, etc.). In one example, the example operating system 175, communicatively coupled to the example user-input device 100 via the communication nodes 140, 170, configures a respective one of the example first keyboard 115 and the example second keyboard 230 in an “upward” position as the active “first” user-input device (e.g., the example first keyboard 115 of FIG. 2A) via hardware, firmware and/or software. For example, a user accesses an example external system 110 of FIG. 1 with the example first keyboard 115 (see, e.g., FIG. 2A) in an upward position and the operating system 175 of the example external system 110, responsive to the determined orientation, configures the example first keyboard 115 as the active keyboard via the communication nodes 140, 170. At block 315, the operating system 175 may deactivate the “second” input device (e.g., the second keyboard 230 in FIG. 2B) to disable the second input device from providing user inputs to the operating system 175 or applications 180.

Block 330 represents a continuing (e.g., continuous, intermittent, periodic, aperiodic, etc.) monitoring of the orientation of the example user-input device 100 by the example orientation analyzer 130 to determine, in block 340, whether a threshold change in orientation of the example user-input device 100 has occurred. In the example user-input device 100 of FIGS. 2A-2B, which is a two-sided user-input device, the threshold change in orientation could be represented by a specific orientation (e.g., the example first keyboard 115 is disposed in an “upward” position or the example second keyboard 230 is disposed in an “upward” position, etc.), a specified change in orientation (e.g., the example first keyboard 115 is rotated through an angle of about 180°), or a change falling within a range of orientations (e.g., the example first keyboard 115 is rotated through an angle of about 160°, which falls within a user-setting of between about 150°-180° and which prompts the operating system 175 to deactivate the example first keyboard and activate the example second keyboard 230). In other examples, where a user-input device has more than two operative sides, other values for the threshold change could be used or selected.

If, in block 340, the example orientation analyzer 130 determines that a threshold change in orientation of the example user-input device 100 has not occurred, the example orientation analyzer 130 continues to monitor the orientation of the example user-input device 100. If, in block 340, the example orientation analyzer 130 determines that a threshold change in orientation of the example user-input device 100 has occurred, the example orientation analyzer 130, in block 345, provides orientation information relating to the example user-input device 100 to the example external system 110, via the communication nodes 140, 170. Responsive to this orientation information, the example external system 110, in block 350, then activates a “second” input device of the example user-input device 100 (e.g., the example second keyboard 230 of FIG. 2B), via hardware, firmware and/or software, responsive to the changed orientation of the example user-input device 100. In one example, the example operating system 175, communicatively coupled to the example user-input device 100 via the communication nodes 140, 170, configures a respective one of the example first keyboard 115 and the example second keyboard 230 in an “upward” position as the active “first” user-input device (e.g., the example first keyboard 115 of FIG. 2A) via hardware, firmware and/or software.

Thus, in an example where the first keyboard 115 of FIG. 2A was initially activated, a determination by the example orientation analyzer 130 that the first keyboard 115 is being, or has been, flipped over to a “downward” position, causes the example external system 110 (e.g., the example operating system 175, etc.) to enable the “second” input device of the example user-input device 100 (e.g., the example second keyboard 230 of FIG. 2B) and to disable the “first” input device (e.g., the example first keyboard 115 of FIG. 2A of the example user-input device 100.

To illustrate, during a user's session on the example external system 110, the user switches away from a first application 180 (e.g., a word processing program) in which the user used the first keyboard 115 and places a second application 180 (e.g., a CAD application) in the foreground of the example external system 110. The user then flips the example user-input device 100 over (e.g., a 180° rotation) so that the display input device 117 (e.g., the second keyboard 230 in FIG. 2B) is facing upwardly in the field of view of the user. The example orientation analyzer 130, monitoring the orientation of the example user-input device 100 (block 330), detects the altered orientation of the example user-input device 100 (block 340), and the operating system 175 of the external system 110 then configures the example second keyboard 230 as the “active” keyboard via the communication nodes 140, 170 and deactivates the first keyboard 115 (block 350).

In block 352, the example application graphical user interface (GUI) mapper 150 receives application information from the example external system 110, such as information relating to an application 180 in a foreground of the example external system 110. This application information may be transmitted from the example external system 110 periodically, aperiodically, continuously, or responsive to an event (e.g., responsive to a communicated change in orientation information, etc.).

In block 355, the example application graphical user interface (GUI) mapper 150, responsive to the application information, maps application functions from example application 180 running on the example external system 110 to the example display input device 117 of the user-input device 100, each application function being represented by a user-selectable object, such as an icon or a soft key. In one example, this mapping is performed for an application 180 residing in a foreground or “top window” of the example operating system 175 or, stated differently, an application 180 that the user of the external system 110 is currently utilizing or that has focus. As noted above, FIG. 2B shows an example of a mapping of an example second section 250 of the example second keyboard 230 with a plurality of example user-selectable objects 255 representing various application 180 example functions (e.g., computer-aided design (CAD) application functions, etc.).

In this new position of the “second” input device (e.g., the example second keyboard 230 of FIG. 2B), the example orientation analyzer 130 continues to monitor and analyze, in block 360, an orientation of the example user-input device 100. This monitoring and analysis enables, in block 370, a determination as to whether a threshold change in orientation of the example user-input device 100 has occurred.

If, in block 370, the example orientation analyzer 130 determines that a threshold change in orientation of the example user-input device 100 has occurred, the example orientation analyzer 130, in block 375, provides orientation information relating to the example user-input device 100 to the example external system 110, via the communication nodes 140, 170. Responsive to this orientation information, the external system, in block 320, then activates the “first” input device of the example user-input device 100 (e.g., the example first keyboard 115) responsive to the changed orientation of the example user-input device 100. Thus, continuing with the above example, wherein the second keyboard 230 of FIG. 2B was active, a determination by the example orientation analyzer 130 that the second keyboard 230 is being or has been flipped over to a “downward” position, causes enabling of the “first” input device of the example user-input device 100 (e.g., the example first keyboard 115). The operating system 175 then activates the “first” input device (e.g., example first keyboard 115) and deactivates the “second” input device (e.g., the second keyboard 230).

The illustrated example of FIG. 3 represents a case sequentially during usage where the first user input device is the example first keyboard 115 and the second user input device is the example second keyboard 230 of the example display input device 117. Alternatively, the first user input device may be the example second keyboard 230 of the example display input device 117 and the second user input device may be the example first keyboard 115, with corresponding rearrangement of blocks (e.g., rearrangement of blocks 350, 352 and 355 with block 320).

In accord with an example of the teachings herein, an example user-input device 100 includes a standardized keyboard 115, with standard key actuations on one side, and a display input device 117 on the other side to provide distinct display-based keyboards 230. The display input device 117 enables a user to completely customize a layout of desired user-input functions for applications 180 running on an external system 110. The combination of the standard keyboard 115 and the display input device 117 in the same user-input device enables the user to easily switch between workflows without requiring two separate devices. The user is thus able to configure the example second keyboard 230, and more particularly the example second portion 250 of the example second keyboard 230, to suit their usage and needs. The sensor 120, disclosed herein, enables dynamic reconfiguration of a user-input device 100 the particularly suit the foreground application in use by the user, even as the application in the foreground changes during use. In this manner, the user always has the most appropriate input layout for the active workflow.

In accord with teachings herein, the user-input device 100 having the example second keyboard 230 as a compliment to the first keyboard 115 may further reduce supply chain complexity by providing a product with a single stock keeping unit (SKU) able to be shipped world-wide and to provide a configurable platform supporting any language via software download.

As noted above. FIG. 4 is a block diagram of an example processor platform 400 capable of executing the instructions of the example programs 300 of FIG. 3. In various aspects, the processor platform 400 is, by way of example, a server, a desktop computer, a laptop computer, television, display device, port replicator, terminal, mobile device (e.g., a tablet computer, such as an iPad™), or any other type of computing device.

The processor platform 400 of the illustrated example includes a processor 412. The processor 412 of the illustrated example is hardware. For example, the processor 412 can be implemented by integrated circuits, logic circuits, microprocessors or controllers from any desired family or manufacturer.

The processor 412 of the illustrated example includes a local memory 413 (e.g., a cache). The processor 412 of the illustrated example is in communication with a main memory including a volatile memory 414 and a non-volatile memory 416 via a bus 418. The volatile memory 414 may be implemented by Synchronous Dynamic Random Access Memory (SDRAM), Dynamic Random Access Memory (DRAM), RAMBUS Dynamic Random Access Memory (RDRAM) and/or any other type of random access memory device. The non-volatile memory 416 may be implemented by flash memory and/or any other desired type of memory device. Access to the main memory 414, 416 is controlled by a memory controller.

The processor platform 400 of the illustrated example also includes an interface circuit 420. The interface circuit 420 may be implemented by any type of interface standard, such as an Ethernet interface, a universal serial bus (USB), and/or a PCI express interface.

In the illustrated example, input device(s) 422 are connected to the interface circuit 420. The input device(s) 422 permit(s) a user to enter data and commands into the processor 412. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 424 are also connected to the interface circuit 420 of the illustrated example. The output devices 424 can be implemented, for example, by display devices (e.g., a light emitting diode (LED), an organic light emitting diode (OLED), a liquid crystal display, a cathode ray tube display (CRT), a touchscreen, a tactile output device, a printer, speakers, etc.). The interface circuit 420 of the illustrated example, thus, typically includes a graphics driver card, a graphics driver chip or a graphics driver processor.

The interface circuit 420 of the illustrated example also includes a communication device such as a transmitter, a receiver, a transceiver, a modem and/or network interface card to facilitate exchange of data with external machines (e.g., computing devices of any kind) via a network 426 (e.g., an Ethernet connection, a digital subscriber line (DSL), a telephone line, coaxial cable, a cellular telephone system, etc.).

The processor platform 400 of the illustrated example also includes mass storage devices 428 for storing software and/or data. Examples of such mass storage devices 428 include floppy disk drives, hard drive disks, compact disk drives, Blu-ray disk drives, RAID systems, and digital versatile disk (DVD) drives.

The coded instructions 432 of FIG. 4, represented generally in FIG. 3, or in any other methods and processes disclosed herein, may be stored in the mass storage device 428, in the volatile memory 414, in the non-volatile memory 416, and/or on a removable tangible computer readable storage medium such as a CD or DVD.

It is to be further noted that, although FIG. 1 represents an example configuration of elements that may be advantageously utilized in combination with the example user-input device 100 disclosed herein, in accordance with some teachings of the disclosure, the example sensor 120 and/or example orientation analyzer 130 are disposed externally to the user-input device 100. By way of example, the example sensor 120 may comprise a conductive mat upon which the user-input device 100 lays. Contacts are provided on the example user-input device 100 differentiating a first side of the example user-input device 100 from a second side of the example user-input device 100 (e.g., a different placement of contacts, etc.) to enable the example orientation analyzer 130 to inform the example external system 110 and/or the application GUI mapper 150 as to the orientation of the example user-input device 100.

In another example, the application GUI mapper 150 may support not only a plurality of application preferences for a single user, but also a plurality of application preferences for a plurality of users who may interact with the same example user-input device 100, such as at a workstation terminal.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. A user-input device comprising:
a first side including a first keyboard having a plurality of movable pushbuttons;
a second side including a display input device;
an orientation sensor;
an orientation analyzer to determine an orientation of the user-input device; and
a communication node to communicate a determined orientation of the user-input device to an external system.

2. The user-input device of claim 1, wherein the orientation sensor includes at least one accelerometer, gyroscope, or orientation switch, or a combination thereof.

3. The user-input device of claim 2,
wherein the display input device includes a single touch-screen display, or a plurality of adjacent touch-screen displays, and
wherein the second side is a side of the user-input device opposite to the first side.

4. The user-input device of claim 2, further including:
an application graphical user interface mapper to map application functions to the display input device, each function being represented by a user-selectable object.

5. The user-input device of claim 4, wherein the mapping of the application functions by the application graphical user interface mapper occurs responsive to receipt of application information from the external system via the communication node.

6. The user-input device of claim 5, wherein the application functions correspond to an application in a foreground of the external system identified by the application information.

7. A method, comprising:
determining an orientation of a user-input device including a physical keyboard disposed on a first side and a display input device on a second side using orientation information from an orientation sensor; and
displaying, on at least a portion of a display input device, a plurality of user-selectable objects representing functions of an application on an external system, responsive to an orientation of the user-input device being within a predetermined range of orientations.

8. The method of claim 7,
wherein the external system includes an orientation analyzer to analyze the orientation information from the orientation sensor.

9. The method of claim 7, wherein the orientation sensor includes at least one accelerometer, gyroscope, or orientation switch, or a combination thereof.

10. The method of claim 7, wherein the predetermined range of orientations corresponds to positions presenting the display input device of the user-input device to a user's field of view.

11. The method of claim 7, further including:
identifying, from the received application information, a foreground application of the external system; and
mapping the plurality of user-selectable objects to the display input device responsive, the plurality of user-selectable objects representing functions of the foreground application.

12. A computer system comprising:
a processor;
a storage coupled to the processor, and
a user-input device including an orientation sensor to obtain orientation information, a first communication node, a first keyboard with a plurality of movable pushbuttons on a first side of the user-input device, and a display input device on a second side of the user-input device,
wherein an instruction set on the storage is to cooperate with the processor to determine an orientation of the user-input device using the orientation information and to display a predetermined plurality of user-selectable objects, corresponding to an application on an external system to which the user-input device is communicatively coupled via the first communication node, on at least a portion of the display input device of the user-input device if the determined orientation of the user-input device is within a predetermined range of orientations.

13. The computer system of claim 12, wherein the predetermined range of orientations corresponds to positions presenting the display input device of the user-input device to a user's field of view.

14. The computer system of claim 12, wherein the predetermined plurality of user-selectable objects corresponds to functions of an application in a foreground of the computer system.

15. The computer system of claim 12, further including:
an orientation analyzer to determine, from the orientation information, an orientation of the user-input device, and
an application graphical user interface mapper to map the predetermined plurality of user-selectable objects to predetermined locations of the display input device.
